(19) United States
(12) Patent Application Publication
(10) Pub. No.: US 2025/0317896 A1
(43) Pub. Date: Oct. 9, 2025

(54) SYSTEMS AND METHODS FOR ADAPTIVE PAGING

(71) Applicant: Verizon Patent and Licensing Inc., Basking Ridge, NJ (US)

(72) Inventors: Helen Osias EGLIP, Sammamish, WA (US); Rishi TANDON, Gurugram (IN); Tony FERREIRA, Greenwich, CT (US); Kristen Sydney YOUNG, Mine Hill, NJ (US)

(73) Assignee: Verizon Patent and Licensing Inc., Basking Ridge, NJ (US)

(21) Appl. No.: 18/626,264

(22) Filed: Apr. 3, 2024

(51) Int. Cl. H04W 68/02; H04W 64/00; H04W 68/06

(52) U.S. Cl. CPC H04W 68/02; H04W 64/006; H04W 68/06

(57) ABSTRACT

In some implementations, a first network device may receive, log data identifying user equipment (UE) mobility information for a set of UEs. The first network device may train a model of UE mobility based on the log data. The first network device may receive based on training the model of UE mobility, UE mobility information for a particular UE. The first network device may analyze, using the model of UE mobility, the UE mobility information for the particular UE to predict a location of the particular UE. The first network device may generate, based on predicting the location of the particular UE, a set of recommended cells for paging the particular UE. The first network device may transmit, to the second network device, information identifying the set of recommended cells.

### BACKGROUND

In some communications systems, a network node may transmit a paging message to a user equipment (UE) to notify the UE regarding incoming data, call requests, or network updates, among other examples. For example, a UE may transition from an active mode to an idle mode to reduce power consumption during a period of time in which the UE is not communicating. However, periodically, the UE may receive a paging message that triggers the UE to transition from the idle mode back to the active mode, in which the UE can communicate with the network node.

### BRIEF DESCRIPTION OF THE DRAWINGS

FIGS. 1A-1C are diagrams of an example associated with adaptive paging.

FIG. 2 is a diagram of an example associated with adaptive paging.

FIGS. 3A and 3B are diagrams of an example environments in which systems and/or methods described herein may be implemented.

FIG. 4 is a diagram of example components of a device associated with adaptive paging.

FIG. 5 is a flowchart of an example process associated with adaptive paging.

### DETAILED DESCRIPTION OF EXAMPLE EMBODIMENTS

The following detailed description of example implementations refers to the accompanying drawings. The same reference numbers in different drawings may identify the same or similar elements.

Some communications systems may have a centralized virtualized radio access network (VRAN) with a split central unit (CU) and distributed unit (DU) architecture. Within such a network structure, a CU may incorporate multiple DUs, and each DU may provide multiple cells. This may result in a single CU being associated with many more cells than in legacy network architectures (e.g., non-split CU-DU architectures). In legacy network architectures, a paging procedure may include paging a last known cell of a base station, paging at a base station level (e.g., a set of cells of a base station), paging at a Tracking Area Identifier (TAI) (e.g., a set of base stations of a TAI) level, and/or paging at a TAI list level (e.g., a set of TAIs). At each level, a quantity of paging messages that are transmitted increases.

However, in a VRAN context with a split CU-DU architecture, the quantity of cells at each level may be significantly greater. For example, at a level of a single CU, there may be multiple DUs, each with multiple cells. Similarly, at a level of a TAI, there may be multiple CUs, each with multiple DUs, each with multiple cells. As a result of the increased quantity of cells, paging may overload network paging resources. Furthermore, when a hybrid deployment includes both a VRAN split CU-DU architecture and a legacy architecture, a radio access network (RAN) may lack a control scheme for differentiating between different paging schemes for different architectures.

Some implementations described herein provide an adaptive paging system that enhances the efficiency of paging schemes in networks, such as networks that include a centralized VRAN and a split CU-DU architecture or hybrid networks, among other examples. For example, a first network device (e.g., a network data analytics function (NWDAF)) may receive log data identifying user equipment (UE) mobility information from a second network device (e.g., an access and mobility management function (AMF)) and may train a model of UE mobility based on the log data. The first network device may use the model to predict a location of a particular UE (e.g., a current location or a future location). The first network device can generate a list of a set of recommended cells for paging the particular UE and transmit this information to the second network device, which may page the particular UE. In some implementations, the adaptive paging system may revert to a default paging scheme, such as when artificial intelligence (AI) or machine learning (ML) (AI/ML) is disabled, when a NWDAF does not provide accurate paging information, or when paging via a legacy architecture (e.g., in a hybrid deployment).

In this way, the first network device may use a machine learning model to predict UE location, thereby allowing for a more targeted paging process than a static paging process at different granularity levels. The targeted process conserves RAN resources by reducing a quantity of cells involved in the paging process, thereby decreasing signaling overhead and a potential for paging channel congestion. The adaptability of the first network device and second network device to enable or disable the AI/ML model based on performance or network conditions ensures that the RAN can maintain paging efficiency and facilitate deployment of hybrid architectures. By providing an adaptive paging system, some implementations described herein optimize an allocation and usage of RAN resources, which can lead to reduced energy consumption and improved network sustainability. Further, the adaptive paging system reduces a processing load on network infrastructure, which can extend a lifespan of network equipment and reduce a need for frequent upgrades.

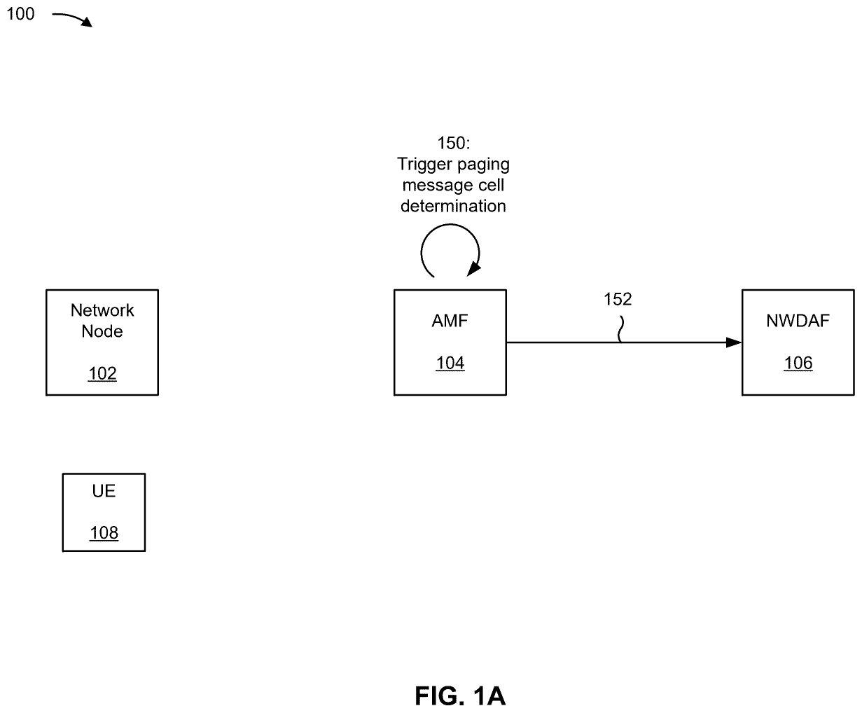

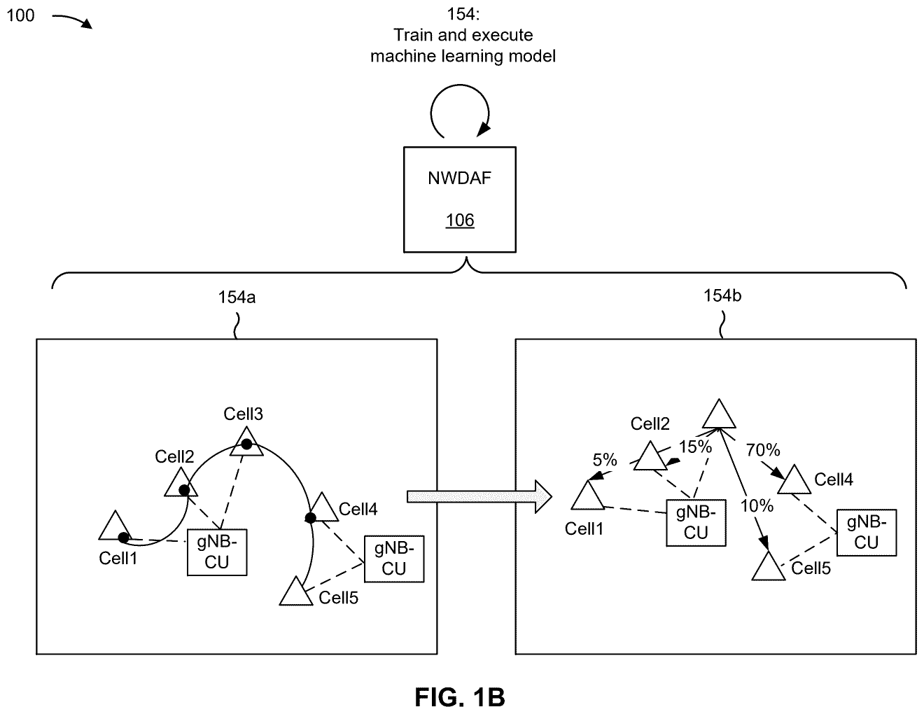

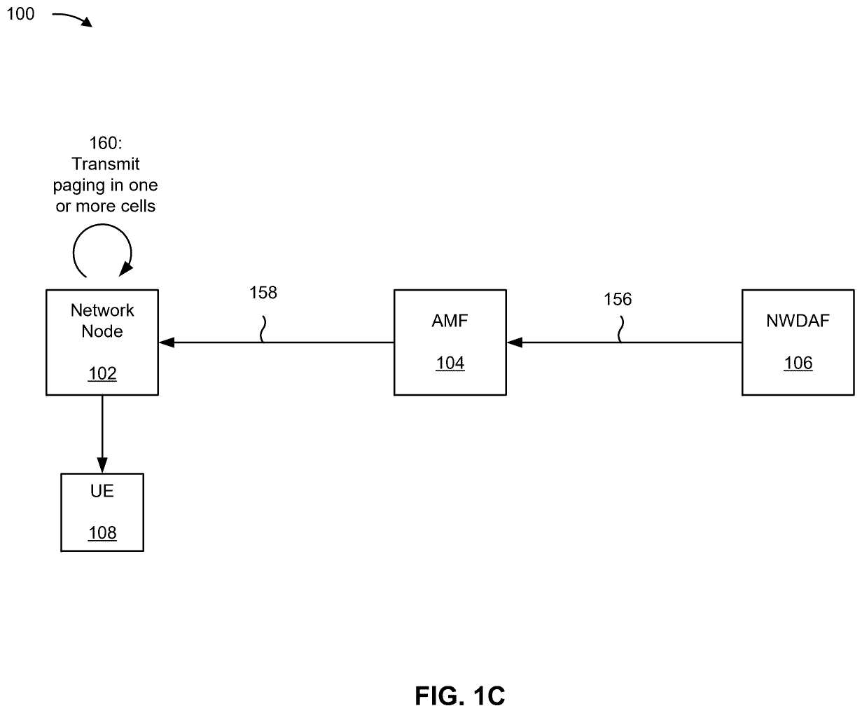

FIGS. 1A-1C are diagrams of an example 100 associated with adaptive paging. As shown in FIGS. 1A-1C, example 100 includes a network node 102, an AMF 104, an NWDAF 106, and a UE 108.

As shown in FIG. 1A, and by reference number 150, the AMF 104 may trigger a paging message cell determination. For example, the AMF 104 may request information identifying a cell list for paging the UE 108 (e.g., via the network node 102). In some implementations, the AMF 104 may trigger a paging message cell determination based on receiving information associated with triggering paging. For example, when a call is placed to the UE 108 (e.g., from another UE) and when the UE 108 is operating in an idle mode (e.g., a reduced power mode), the AMF 104 may receive an indicator of the incoming call and may initiate paging of the UE 108. The AMF 104 may trigger a paging message cell determination to initiate the paging of the UE 108. In this case, the paging is associated with triggering the UE 108 to transition from the idle mode to an active mode (e.g., a full power mode) in which the UE 108 can receive the call (e.g., from another UE). Additionally, or alternatively, the AMF 104 may initiate paging and an associated paging message cell determination when there is incoming data for the UE 108 (e.g., from an application server) or a network update for the UE 108. Additionally, or alternatively, the AMF 104 may trigger paging and an associated paging message cell determination on a periodic basis. For example, the AMF 104 may be configured with a particular periodicity for paging one or more UEs and may, when a threshold amount of time has elapsed, trigger paging for the UE 108 to determine a status of the UE 108.

As further shown in FIG. 1A, and by reference number 152, the AMF 104 may transmit a message to the NWDAF 106. For example, the AMF 104 may transmit log data identifying UE mobility information. The log data may include information regarding the UE 108 when the UE 108 was operating in an active state during one or more sampled period intervals. For example, when the UE 108 is in an active state, the UE 108 may perform one or more handover procedures or tracking area update (TAU) procedures with the network node 102 (or other network nodes). In this case, the AMF 104 may store event report data (e.g., a log) identifying active state transitions (e.g., when the UE 108 transitions between the active state and an inactive or idle state). Similarly, the AMF 104 may store handover log information. For example, the AMF 104 may receive information indicating that the UE 108 has handed over between network nodes 102 and may store log data identifying the handover time, a location at which the handover occurred, or a set of cells between which the UE 108 transitioned during a handover, among other examples. Additionally, or alternatively, AMF 104 may receive information identifying the handover procedures or TAU procedures, among other examples, and store information, such as when a procedure occurred, a location of the UE 108 when the procedure occurred, or which cells the UE 108 was transitioning between, among other examples. Accordingly, the AMF 104 may transmit information identifying the event report data to the NWDAF 106 for analysis.

In some implementations, the AMF 104 may transmit information identifying UE mobility information for the UE 108. For example, the AMF 104 may transmit information regarding mobility of the UE 108 for training of an AI/ML model of UE mobility specific to the UE 108. Additionally, or alternatively, the AMF 104 may transmit information identifying UE mobility information for a set of UEs (e.g., which may or may not include the UE 108). In this case, the NWDAF 106 may train a model of UE mobility specific to the set of UEs, to a set of cells in which the set of UEs operated, to a time period in which the set of UEs were observed, or with another granularity.

As shown in FIG. 1B, and by reference number 154, the NWDAF 106 may train and execute a model of UE mobility. For example, the NWDAF 106 may train an AI/ML model to predict a path or trajectory of the UE 108. In some implementations, the NWDAF 106 may train the model of UE mobility based on data specific to the UE 108. For example, the NWDAF 106 may receive log data for the UE 108 and may train an AI/ML model specific to the UE 108 for generating a prediction associated with the UE 108. In this way, the NWDAF 106 may train an AI/ML model with a high degree of accuracy for specific movements of the UE 108 (e.g., a specific route traveled, repeatedly, by a user of the UE 108, such as a route from a home location to a work location). Additionally, or alternatively, the NWDAF 106 may use log data relating to other UEs to generate an AI/ML model. In this case, the NWDAF may analyze log data of the UE 108 using the AI/ML model trained on log data for other UEs to generate a prediction. In this way, the NWDAF 106 may train an AI/ML model with a high degree of accuracy for movements common to many UEs (e.g., UEs traveling along a fixed train route or highway route).

In some implementations, the NWDAF 106 may train the AI/ML model to predict a direction and location of the UE 108 based on a mobility path and an amount of elapsed time from a last known location of the UE 108. In other words, as shown in FIG. 1B, and by reference number 154a, the NWDAF 106 may use an AI/ML model trained on known locations of the UE 108 in a first cell, a second cell, and a third cell of a first gNodeB (gNB) CU (gNB-CU) and a known location of the UE 108 in a fourth cell of a second gNB-CU to predict a trajectory that includes the UE 108 traveling toward a fifth cell of the second gNB-CU. Additionally, or alternatively, the NWDAF 106 may determine movement pattern information, such as predicting a pattern with which the UE 108 moves (e.g., such as predicting movement between a pair of locations or movement along an identified route). In this example, the first gNB-CU and/or second gNB-CU may correspond to the network node 102 or a parent node or child node thereof. In this case, the NWDAF 106 may generate a set of recommended cells in which the fifth cell is a best cell for paging (e.g., most likely to include the UE 108), the fourth cell is a next best cell for paging, and so forth.

Additionally, or alternatively, the NWDAF 106 may train a machine learning model to predict a cell, whose coverage area includes the UE 108 and can be used for paging the UE 108. For example, the NWDAF 106 may train a probability model for assigning, to different cells, respective probabilities of the UE 108 being located therein for paging. In other words, as shown in FIG. 1B, and by reference number 154b, the NWDAF 106 may use an AI/ML model to assign, to a UE last known to be operating in an active mode in the third cell, a 5% probability to the first cell, a 15% probability to the second cell, a 70% probability to the fourth cell, and a 10% probability to the fifth cell. In this case, the NWDAF 106 may generate a set of recommended cells in which the third cell is the best cell for paging (e.g., having been the last cell in which the UE 108 was observed), the fourth cell is a next best cell for paging (e.g., having a highest probability), the second cell is a next best cell for paging (e.g., having the second highest probability), and so forth.

As shown in FIG. 1C, and by reference number 156, the NWDAF 106 may transmit a message to the AMF 104. For example, the NWDAF 106 may transmit information identifying a cell list, which includes a set of recommended cells for transmitting paging to the UE 108. In some implementations, the NWDAF 106 may transmit information identifying an output of a model of UE mobility. For example, the NWDAF 106 may transmit information identifying a set of probabilities for a set of cells (e.g., a probability that the UE 108 is in a coverage area of each cell of the set of cells), from which the AMF 104 may generate a cell list for paging. Additionally, or alternatively, the NWDAF 106 may generate the cell list for paging and transmit the cell list as a set of recommended cells for the AMF 104 to use for paging.

As further shown in FIG. 1C, and by reference numbers 158 and 160, the AMF 104 and the network node 102 may page the UE 108. For example, the AMF 104 may transmit a message to the network node 102 to cause the network node 102 to transmit paging to the UE 108 on a selected cell. In some implementations, the AMF 104 may transmit paging via a single network node 102. For example, the AMF 104 may transmit paging to the network node 102 for further transmission via one or more cells of the network node 102 based on the one or more cells being included in the set of recommended cells. Additionally, or alternatively, the AMF 104 may transmit paging via multiple network nodes. For example, the AMF 104 may transmit paging via a first cell of a first network node, a second cell of a second network node, or a third cell of a third network node, among other examples.

In some implementations, the AMF 104 may transmit the paging toward a UE 108. For example, the AMF 104 may attempt to transmit paging to the UE 108 in a first selected cell, but may be unsuccessful (e.g., when the UE 108 is not in the first selected cell). In this case, the AMF 104 may next attempt to transmit paging toward the UE 108 in a second selected cell and may be successful, thereby transmitting the paging to the UE 108, based on the UE 108 operating (e.g., being idle) in the second selected cell. In some implementations, the AMF 104 may cause multiple paging messages to be transmitted toward the UE 108 concurrently. For example, AMF 104 may cause a first paging message to be transmitted in a first selected cell and a second paging message to be transmitted in a second selected cell, to reduce a latency associated with successfully paging the UE 108. Based on the UE 108 successfully receiving a paging message, the UE 108 may initiate a radio resource control (RRC) procedure (e.g., an RRC reconnect procedure) to transition from an idle mode to an active mode (e.g., to enable the UE 108 to receive an incoming call, incoming data, or a network update).

As indicated above, FIGS. 1A-1C are provided as an example. Other examples may differ from what is described with regard to FIGS. 1A-1C. The number and arrangement of devices shown in FIGS. 1A-1C are provided as an example. In practice, there may be additional devices, fewer devices, different devices, or differently arranged devices than those shown in FIGS. 1A-1C. Furthermore, two or more devices shown in FIGS. 1A-1C may be implemented within a single device, or a single device shown in FIGS. 1A-1C may be implemented as multiple, distributed devices. Additionally, or alternatively, a set of devices (e.g., one or more devices) shown in FIGS. 1A-1C may perform one or more functions described as being performed by another set of devices shown in FIGS. 1A-1C.

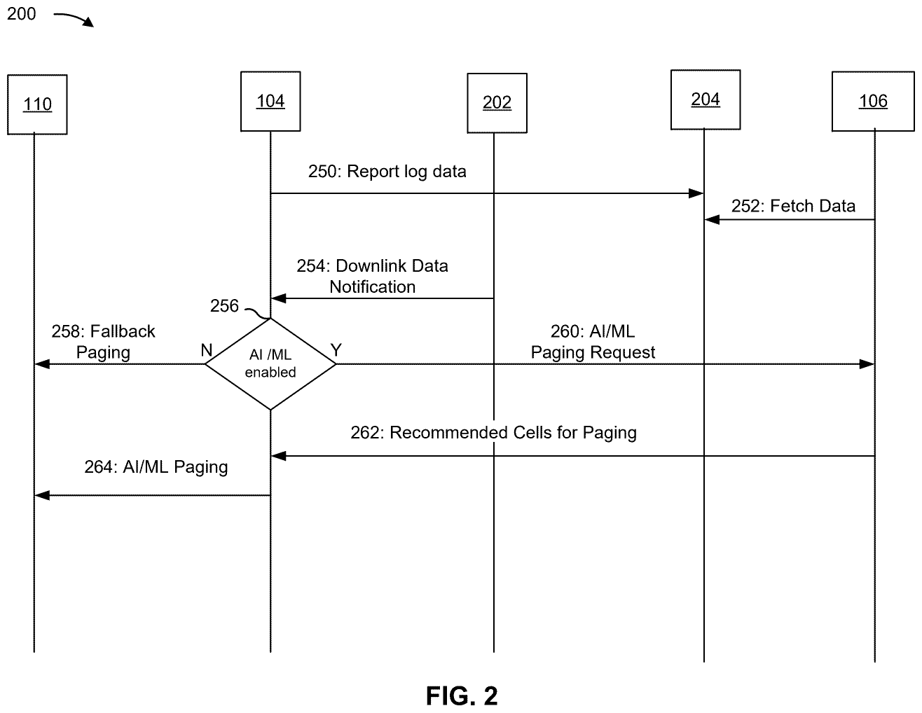

FIG. 2 is a diagram of an example 200 associated with adaptive paging. As shown in FIG. 2, example 200 includes a network node 102, an AMF 104, a session management function (SMF) 202, a data repository 204, and an NWDAF 106.

As further shown in FIG. 2, and by reference number 250, the AMF 104 may transmit log data, which may include UE location information or location data, to the data repository 204. For example, when the AMF 104 records log data, such as a UE handover procedure or a UE TAU procedure, the AMF 104 may store the log data in the data repository 204. In this case, the AMF 104 may store, in the data repository 204, information identifying the UE (e.g., the UE 108), a location of the UE, a status of the UE, a cell whose coverage area includes the UE, one or more other cells to which the UE has access, or another parameter. As shown by reference number 252, the NWDAF 106 may fetch data from the data repository 204. For example, the NWDAF 106 may request and receive data from the data repository 204 to train an AI/ML model (e.g., based on a request from the AMF 104). Additionally, or alternatively, the NWDAF 106 may receive a notification when new data is stored in the data repository 204 and may fetch the new data to periodically update the AI/ML model (e.g., by retraining the AI/ML model using updated UE mobility information). For example, when the NWDAF 106 provides information identifying a set of recommended cells and the AMF 104 performs paging successfully, the AMF 104 may report feedback information identifying for which cell paging was successful, and the NWDAF 106 may retrain the AI/ML model based on the feedback information.

As further shown in FIG. 2, and by reference number 254, the AMF 104 may receive a downlink data notification from the SMF 202. For example, when downlink data is available for a UE (e.g., the UE 108), the SMF 202 may request that the AMF 104 page the UE to cause the UE to transition to an RRC active mode in which the UE can be assigned resources for receiving the downlink data. Additionally, or alternatively, the AMF 104 may receive a request for paging associated with a handover request or a TAU procedure. As shown by reference number 256, the AMF 104 may determine whether use of an AI/ML model is enabled. For example, the AMF 104 may adaptively enable or disable use of an AI/ML model for paging. The AMF 104 may disable use of the AI/ML model when one or more prior predictions from the NWDAF 106 have been inaccurate or when a hybrid network deployment is configured. In the former example, when the NWDAF 106 transmits a set of recommended cells and the set of recommended cells does not include a cell in whose coverage area a UE is operating, the AMF 104 may determine that the AI/ML model being used by the NWDAF 106 is inaccurately trained and may disable use of the AI/ML model (e.g., until more data is generated to train the AI/ML model more accurately). In the latter example, when a hybrid network deployment is configured, the AMF 104 may disable use of the AI/ML model when paging via a legacy network node 102 (e.g., which supports, for example, a single cell) and may enable use of the AI/ML model when paging via a distributed CU-DU architecture (e.g., in which the network node 102 may support many cells).

As further shown in FIG. 2, and by reference number 258, when the AI/ML model is disabled or deactivated (or when the AMF 104 does not receive a response form the NWDAF 106 when requesting a set of recommended cells), the AMF 104 may trigger paging (e.g., via the network node 102) using a legacy, default, or fallback paging procedure. For example, the AMF 104 may transmit paging to a last cell in which a UE was active, a last set of cells of a last base station that was connected to the UE, a last set of base stations of a last TAI in which the UE was active, or at another granularity of paging. Such a static paging procedure may enable the AMF 104 to perform paging in a legacy network (e.g., a non-disaggregated base station network) or paging in a disaggregated base station network in which the NWDAF 106 has not provided a set of recommended cells (e.g., as a result of an error or communication interruption).

In contrast, as shown by reference number 260, when the AI/ML model is not disabled or deactivated, the AMF 104 may transmit a request for recommended cells for paging. In this case, the NWDAF 106 may generate a recommendation of a set of recommended cells and provide the recommendation to the AMF 104 for paging via the network node 102, as shown by reference numbers 262 and 264. The NWDAF 106 may identify a set of cells in accordance with a cell global identity (CGI), such as a New Radio (NR) CGI. In some implementations, the list of recommended cells may have a configured quantity of cells, such as up to 16 cells. Based on receiving a list of a set of recommended cells, the AMF 104 may transmit paging, via the network node 102 or one or more other network nodes, using the list of the set of recommended cells. In some implementations, the AMF 104 may use the recommended cells for paging for a configured quantity of paging attempts. In some implementations, the AMF 104 may evaluate the set of recommended cells using one or more evaluation criteria and select one or more cells for paging. For example, the AMF 104 may evaluate whether the set of recommended cells includes cells that are proximate to a last known location of the UE 108 (e.g., to avoid error cases in which an AI/ML prediction provides anomalous data). Additionally, or alternatively, the AMF 104 may determine which cells of the set of recommended cells to page using an optimization criterion. For example, when the set of recommended cells includes cells of multiple network nodes 102, the AMF 104 may select cells of a first network node 102 for paging before cells of a second network node 102. In this case, the AMF 104 may reduce a quantity of messages transmitted, by prioritizing paging through a single network node 102 (e.g., with a plurality of cells) rather than through a plurality of network nodes 102.

As indicated above, FIG. 2 is provided as an example. Other examples may differ from what is described with regard to FIG. 2. The number and arrangement of devices shown in FIG. 2 are provided as an example. In practice, there may be additional devices, fewer devices, different devices, or differently arranged devices than those shown in FIG. 2. Furthermore, two or more devices shown in FIG. 2 may be implemented within a single device, or a single device shown in FIG. 2 may be implemented as multiple, distributed devices. Additionally, or alternatively, a set of devices (e.g., one or more devices) shown in FIG. 2 may perform one or more functions described as being performed by another set of devices shown in FIG. 2.

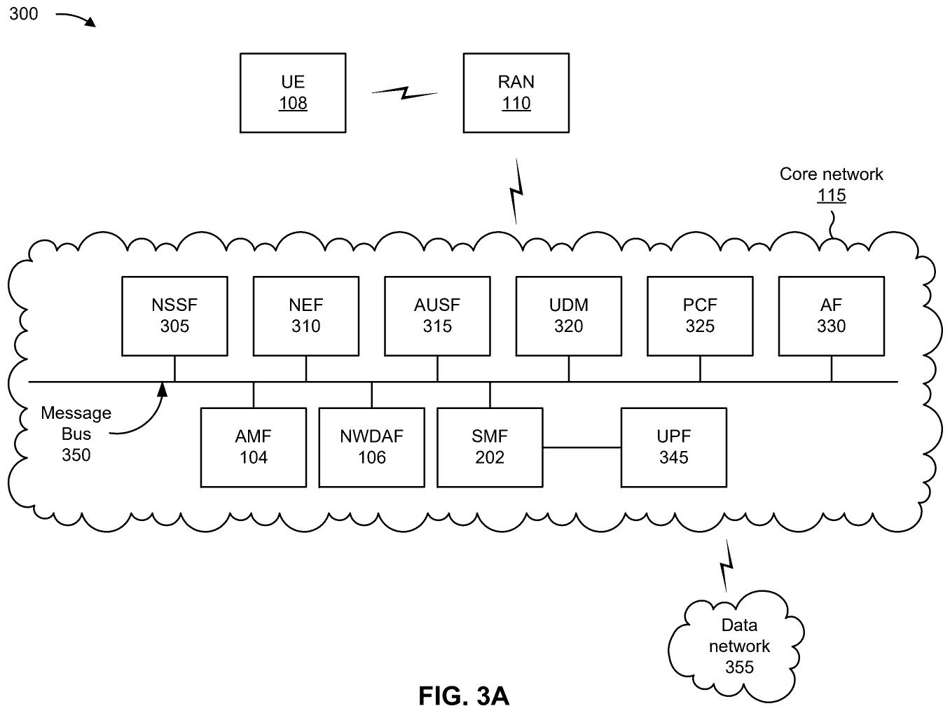

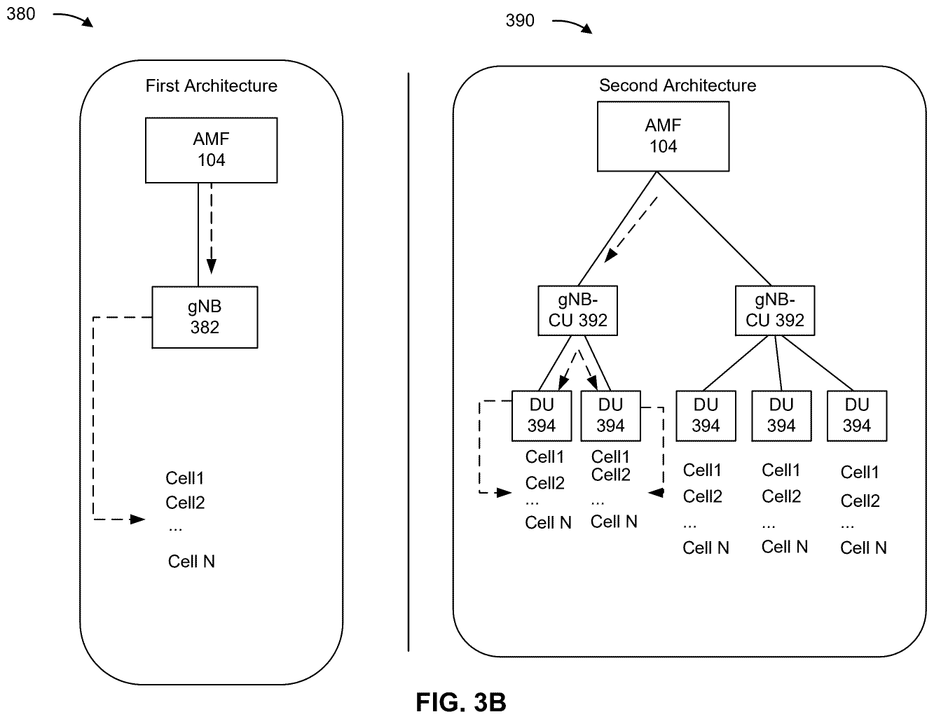

FIGS. 3A and 3B are diagrams of an example environments 300/380/390 in which systems and/or methods described herein may be implemented. As shown in FIG. 3A, example environment 300 may include a UE 108, a RAN 110, a core network 115, and a data network 355. Devices and/or networks of example environment 300 may interconnect via wired connections, wireless connections, or a combination of wired and wireless connections.

UE 108 includes one or more devices capable of receiving, generating, storing, processing, and/or providing information, such as information described herein. For example, UE 108 can include a mobile phone (e.g., a smart phone or a radiotelephone), a laptop computer, a tablet computer, a desktop computer, a handheld computer, a gaming device, a wearable communication device (e.g., a smart watch or a pair of smart glasses), a mobile hotspot device, a fixed wireless access device, customer premises equipment, an autonomous vehicle, or a similar type of device.

RAN 110 may support, for example, a cellular radio access technology (RAT). RAN 110 may include one or more base stations (e.g., base transceiver stations, radio base stations, node Bs, eNodeBs (eNBs), gNodeBs (gNBs), base station subsystems, cellular sites, cellular towers, access points, transmit receive points (TRPs), radio access nodes, macrocell base stations, microcell base stations, picocell base stations, femtocell base stations, or similar types of devices) and other network entities that can support wireless communication for UE 108. RAN 110 may transfer traffic between UE 108 (e.g., using a cellular RAT), one or more base stations (e.g., using a wireless interface or a backhaul interface, such as a wired backhaul interface), and/or core network 115. RAN 110 may provide one or more cells that cover geographic areas.

In some implementations, RAN 110 may perform scheduling and/or resource management for UE 108 covered by RAN 110 (e.g., UE 108 covered by a cell provided by RAN 110). In some implementations, RAN 110 may be controlled or coordinated by a network controller, which may perform load balancing, network-level configuration, and/or other operations. The network controller may communicate with RAN 110 via a wireless or wireline backhaul. In some implementations, RAN 110 may include a network controller, a self-organizing network (SON) module or component, or a similar module or component. In other words, RAN 110 may perform network control, scheduling, and/or network management functions (e.g., for uplink, downlink, and/or sidelink communications of UE 108 covered by RAN 110).

In some implementations, core network 115 may include an example functional architecture in which systems and/or methods described herein may be implemented. For example, core network 115 may include an example architecture of a fifth generation (5G) next generation (NG) core network included in a 5G wireless telecommunications system. While the example architecture of core network 115 shown in FIG. 2 may be an example of a service-based architecture, in some implementations, core network 115 may be implemented as a reference-point architecture and/or a 4G core network, among other examples.

As shown in FIG. 3A, core network 115 may include a number of functional elements. The functional elements may include, for example, a network slice selection function (NSSF) 305, a network exposure function (NEF) 310, an authentication server function (AUSF) 315, a unified data management (UDM) component 320, a policy control function (PCF) 325, an application function (AF) 330, an AMF 104, an SMF 202, a user plane function (UPF) 345, and/or an NWDAF 106. These functional elements may be communicatively connected via a message bus 350. Each of the functional elements shown in FIG. 3A is implemented on one or more devices associated with a wireless telecommunications system. In some implementations, one or more of the functional elements may be implemented on physical devices, such as an access point, a base station, and/or a gateway. In some implementations, one or more of the functional elements may be implemented on a computing device of a cloud computing environment.

NSSF 305 includes one or more devices that select network slice instances for UE 108. By providing network slicing, NSSF 305 allows an operator to deploy multiple substantially independent end-to-end networks potentially with the same infrastructure. In some implementations, each slice may be customized for different services.

NEF 310 includes one or more devices that support exposure of capabilities and/or events in the wireless telecommunications system to help other entities in the wireless telecommunications system discover network services.

AUSF 315 includes one or more devices that act as an authentication server and support the process of authenticating UE 108 in the wireless telecommunications system.

UDM 320 includes one or more devices that store user data and profiles in the wireless telecommunications system. UDM 320 may be used for fixed access and/or mobile access in core network 115.

PCF 325 includes one or more devices that provide a policy framework that incorporates network slicing, roaming, packet processing, and/or mobility management, among other examples.

AF 330 includes one or more devices that support application influence on traffic routing, access to NEF 310, and/or policy control, among other examples.

AMF 104 includes one or more devices that act as a termination point for non-access stratum (NAS) signaling and/or mobility management, among other examples.

SMF 202 includes one or more devices that support the establishment, modification, and release of communication sessions in the wireless telecommunications system. For example, SMF 202 may configure traffic steering policies at UPF 345 and/or may enforce user equipment internet protocol (IP) address allocation and policies, among other examples.

UPF 345 includes one or more devices that serve as an anchor point for intraRAT and/or interRAT mobility. UPF 345 may apply rules to packets, such as rules pertaining to packet routing, traffic reporting, and/or handling user plane QoS, among other examples.

The NWDAF 106 may include one or more devices capable of receiving, generating, storing, processing, providing, and/or routing information associated with a set of recommended cells for paging, as described elsewhere herein. The NWDAF 106 may include a communication device and/or a computing device. For example, the NWDAF 106 may include a server, such as an application server, a client server, a web server, a database server, a host server, a proxy server, a virtual server (e.g., executing on computing hardware), or a server in a cloud computing system. In some implementations, the NWDAF 106 may train and execute a AI/ML model for analyzing UE mobility information and generating a prediction relating to a cell in which a UE 108 can be located for paging. In some implementations, the NWDAF 106 may include computing hardware used in a cloud computing environment.

Message bus 350 represents a communication structure for communication among the functional elements. In other words, message bus 350 may permit communication between two or more functional elements.

Data network 355 includes one or more wired and/or wireless data networks. For example, data network 355 may include an IP Multimedia Subsystem (IMS), a public land mobile network (PLMN), a local area network (LAN), a wide area network (WAN), a metropolitan area network (MAN), a private network such as a corporate intranet, an ad hoc network, the Internet, a fiber optic-based network, a cloud computing network, a third party services network, an operator services network, and/or a combination of these or other types of networks.

As shown in FIG. 3B, a first architecture 380 (e.g., a non-disaggregated architecture), may include the AMF 104 and a network node 102. For example, the AMF 104 may communicate with a gNB 382, which may correspond to a network node 102. The gNB 382 may perform paging in a set of cells 1 through N. In contrast, in a second architecture 390 (e.g., a distributed CU-DU architecture), the AMF 104 may communicate with a set of gNB-CUs 392, which may correspond to network nodes 102. Each gNB-CU 392 may include one or more gNB-DUs 394, which may correspond to network nodes 102. Each gNB-DU 394 may include one or more cells (e.g., a set of cells 1 through N). In some implementations, the AMF 104 may use a legacy, fallback, or default paging scheme for paging in the first architecture 380 (e.g., a first hierarchical paging scheme, such as paging at a gNB level, a gNB list level, a TAI level, and a TAI list level). In contrast, the AMF 104 may use an AI/ML paging scheme for paging in the second architecture 390 (e.g., a second hierarchical paging scheme, such as paging at a recommended cell level, a gNB level, a gNB list level, a TAI level, and a TAI list level). In some implementations, a communications system may include both a first architecture 380 and a second architecture 390. For example, some network nodes 102 may correspond to gNBs 382 with a set of cells and other network nodes 102 may correspond gNB-CUs 392, each with a set of gNB-DUs 394 that include respective sets of cells. In this case, the AMF 104 may determine a paging scheme or paging profile (e.g., a hierarchy) to use based on whether the UE 108 has been last used in a non-distributed base station (e.g., the gNB 382) or in a disaggregated base station (e.g., the gNB-CU 392).

The number and arrangement of devices and networks shown in FIGS. 3A and 3B are provided as examples. In practice, there may be additional devices and/or networks, fewer devices and/or networks, different devices and/or networks, or differently arranged devices and/or networks than those shown in FIGS. 3A and 3B. Furthermore, two or more devices shown in FIGS. 3A and 3B may be implemented within a single device, or a single device shown in FIGS. 3A and 3B may be implemented as multiple, distributed devices. Additionally, or alternatively, a set of devices (e.g., one or more devices) of example environment 300 may perform one or more functions described as being performed by another set of devices of example environment 300.

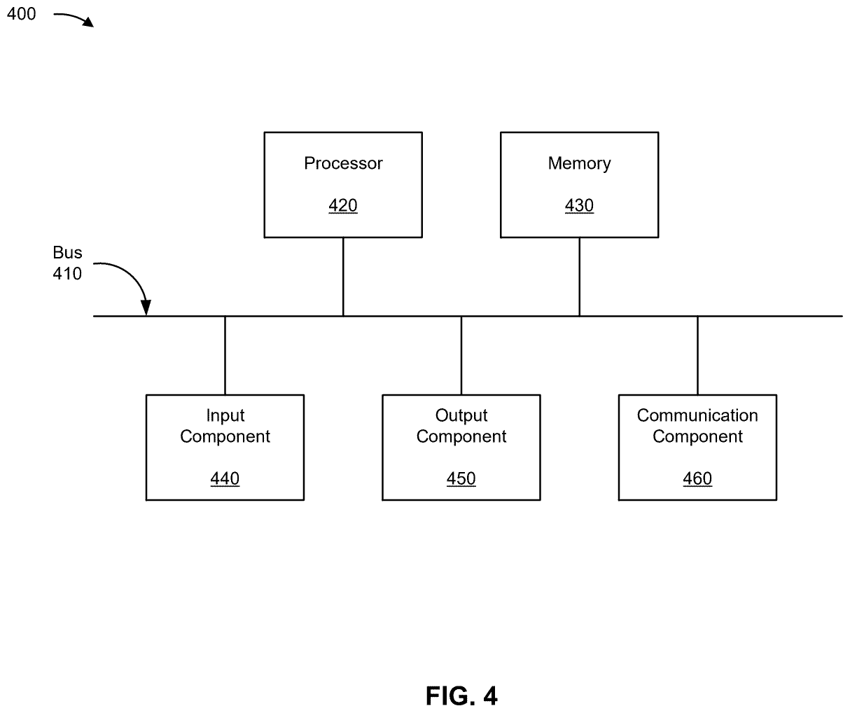

FIG. 4 is a diagram of example components of a device 400 associated with adaptive paging. The device 400 may correspond to network node 102, AMF 104, NWDAF 106, and/or UE 108. In some implementations, network node 102, AMF 104, NWDAF 106, and/or UE 108 may include one or more devices 400 and/or one or more components of the device 400. As shown in FIG. 4, the device 400 may include a bus 410, a processor 420, a memory 430, an input component 440, an output component 450, and/or a communication component 460.

The bus 410 may include one or more components that enable wired and/or wireless communication among the components of the device 400. The bus 410 may couple together two or more components of FIG. 4, such as via operative coupling, communicative coupling, electronic coupling, and/or electric coupling. For example, the bus 410 may include an electrical connection (e.g., a wire, a trace, and/or a lead) and/or a wireless bus. The processor 420 may include a central processing unit, a graphics processing unit, a microprocessor, a controller, a microcontroller, a digital signal processor, a field-programmable gate array, an application-specific integrated circuit, and/or another type of processing component. The processor 420 may be implemented in hardware, firmware, or a combination of hardware and software. In some implementations, the processor 420 may include one or more processors capable of being programmed to perform one or more operations or processes described elsewhere herein.

The memory 430 may include volatile and/or nonvolatile memory. For example, the memory 430 may include random access memory (RAM), read only memory (ROM), a hard disk drive, and/or another type of memory (e.g., a flash memory, a magnetic memory, and/or an optical memory). The memory 430 may include internal memory (e.g., RAM, ROM, or a hard disk drive) and/or removable memory (e.g., removable via a universal serial bus connection). The memory 430 may be a non-transitory computer-readable medium. The memory 430 may store information, one or more instructions, and/or software (e.g., one or more software applications) related to the operation of the device 400. In some implementations, the memory 430 may include one or more memories that are coupled (e.g., communicatively coupled) to one or more processors (e.g., processor 420), such as via the bus 410. Communicative coupling between a processor 420 and a memory 430 may enable the processor 420 to read and/or process information stored in the memory 430 and/or to store information in the memory 430.

The input component 440 may enable the device 400 to receive input, such as user input and/or sensed input. For example, the input component 440 may include a touch screen, a keyboard, a keypad, a mouse, a button, a microphone, a switch, a sensor, a global positioning system sensor, a global navigation satellite system sensor, an accelerometer, a gyroscope, and/or an actuator. The output component 450 may enable the device 400 to provide output, such as via a display, a speaker, and/or a light-emitting diode. The communication component 460 may enable the device 400 to communicate with other devices via a wired connection and/or a wireless connection. For example, the communication component 460 may include a receiver, a transmitter, a transceiver, a modem, a network interface card, and/or an antenna.

The device 400 may perform one or more operations or processes described herein. For example, a non-transitory computer-readable medium (e.g., memory 430) may store a set of instructions (e.g., one or more instructions or code) for execution by the processor 420. The processor 420 may execute the set of instructions to perform one or more operations or processes described herein. In some implementations, execution of the set of instructions, by one or more processors 420, causes the one or more processors 420 and/or the device 400 to perform one or more operations or processes described herein. In some implementations, hardwired circuitry may be used instead of or in combination with the instructions to perform one or more operations or processes described herein. Additionally, or alternatively, the processor 420 may be configured to perform one or more operations or processes described herein. Thus, implementations described herein are not limited to any specific combination of hardware circuitry and software.

The number and arrangement of components shown in FIG. 4 are provided as an example. The device 400 may include additional components, fewer components, different components, or differently arranged components than those shown in FIG. 4. Additionally, or alternatively, a set of components (e.g., one or more components) of the device 400 may perform one or more functions described as being performed by another set of components of the device 400.

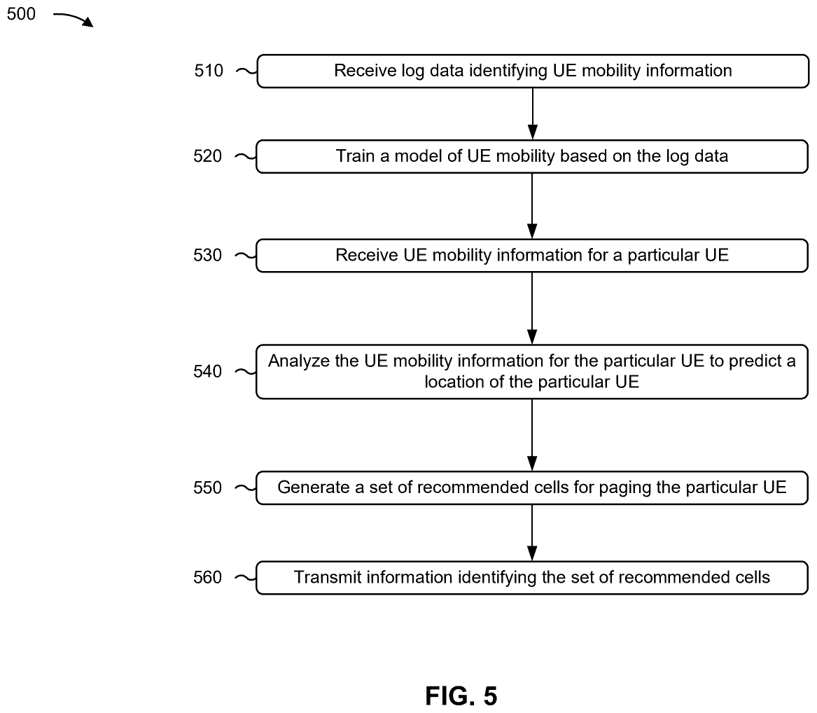

FIG. 5 is a flowchart of an example process 500 associated with adaptive paging. In some implementations, one or more process blocks of FIG. 5 may be performed by a first network device (e.g., NWDAF 06). In some implementations, one or more process blocks of FIG. 5 may be performed by another device or a group of devices separate from or including the first network device, such as a second network device (e.g., AMF 104), a network node (e.g., network node 102), and/or a UE (e.g., the UE 108). Additionally, or alternatively, one or more process blocks of FIG. 5 may be performed by one or more components of device 400, such as processor 420, memory 430, input component 440, output component 450, and/or communication component 460.

As shown in FIG. 5, process 500 may include receiving log data identifying UE mobility information (block 510). For example, the first network device may receive, from a second network device, log data identifying UE mobility information for a set of UEs, as described above. In some implementations, the log data is related to one or more UEs, of the set of UEs, operating in an active state during a sample period interval.

As further shown in FIG. 5, process 500 may include training a model of UE mobility based on the log data (block 520). For example, the first network device may train a model of UE mobility based on the log data, as described above. The first network device may receive updated mobility information for the set of UEs, and updating, by the first network device, the model of UE mobility based on receiving the updated mobility information for the set of UEs. In some implementations, process 500 includes receiving, by the first network device and from the second network device, a request to enable use of the model of UE mobility, and wherein analyzing the UE mobility information for the particular UE to predict the location of the particular UE includes analyzing the UE mobility information for the particular UE using the model of UE mobility based on receiving the request to enable use of the model of UE mobility. In some implementations, the model of UE mobility is a machine learning probability model.

As further shown in FIG. 5, process 500 may include receiving UE mobility information for a particular UE (block 530). For example, the first network device may receive, from the second network device, and based on training the model of UE mobility, UE mobility information for a particular UE, as described above. In some implementations, the first network device may receive a request for a set of recommended cells for paging. In this case, the first network device may transmit information identifying the set of recommended cells based on receiving the request for the set of recommended cells. In some implementations, the particular UE is operating in one or more cells associated with a VRAN with a split CU and DU architecture.

As further shown in FIG. 5, process 500 may include analyzing the UE mobility information for the particular UE to predict a location of the particular UE (block 540). For example, the first network device may analyze, using the model of UE mobility, the UE mobility information for the particular UE to predict a location of the particular UE, as described above. In some implementations, analyzing the UE mobility information for the particular UE includes determining, using the model of UE mobility, a probability of the particular UE being in a particular cell, and determining whether to include the particular cell in the set of recommended cells based on the probability of the UE being in the particular cell.

As further shown in FIG. 5, process 500 may include generating a set of recommended cells for paging the particular UE (block 550). For example, the first network device may generate, based on predicting the location of the particular UE, a list of a set of recommended cells for paging the particular UE, as described above. In some implementations, the first network device may determine the set of recommended cells based on timing information. For example, the first network device may determine the set of recommended cells based on a time of day or a day of a week. In some implementations, the first network device may calculate a movement path of the particular UE, predicting a current or future location of the particular UE based on the movement path, and determine the set of recommended cells based on the movement path.

As further shown in FIG. 5, process 500 may include transmitting, to the second network device, information identifying the set of recommended cells (block 560). For example, the first network device may transmit, to the second network device, information identifying the set of recommended cells, as described above. In some implementations, a default paging scheme is configured for a subsequent paging cycle in which use of the model of UE mobility is disabled. For example, the second network device can disable AI/ML based cell list identification and use a fallback or default paging procedure when the cell list identification is inaccurate or when a paging via a legacy type of network node.

Although FIG. 5 shows example blocks of process 500, in some implementations, process 500 may include additional blocks, fewer blocks, different blocks, or differently arranged blocks than those depicted in FIG. 5. Additionally, or alternatively, two or more of the blocks of process 500 may be performed in parallel.

As used herein, the term “component” is intended to be broadly construed as hardware, firmware, or a combination of hardware and software. It will be apparent that systems and/or methods described herein may be implemented in different forms of hardware, firmware, and/or a combination of hardware and software. The actual specialized control hardware or software code used to implement these systems and/or methods is not limiting of the implementations. Thus, the operation and behavior of the systems and/or methods are described herein without reference to specific software code—it being understood that software and hardware can be used to implement the systems and/or methods based on the description herein.

As used herein, satisfying a threshold may, depending on the context, refer to a value being greater than the threshold, greater than or equal to the threshold, less than the threshold, less than or equal to the threshold, equal to the threshold, not equal to the threshold, or the like.

To the extent the aforementioned implementations collect, store, or employ personal information of individuals, it should be understood that such information shall be used in accordance with all applicable laws concerning protection of personal information. Additionally, the collection, storage, and use of such information can be subject to consent of the individual to such activity, for example, through well known “opt-in” or “opt-out” processes as can be appropriate for the situation and type of information. Storage and use of personal information can be in an appropriately secure manner reflective of the type of information, for example, through various encryption and anonymization techniques for particularly sensitive information.

Even though particular combinations of features are recited in the claims and/or disclosed in the specification, these combinations are not intended to limit the disclosure of various implementations. In fact, many of these features may be combined in ways not specifically recited in the claims and/or disclosed in the specification. Although each dependent claim listed below may directly depend on only one claim, the disclosure of various implementations includes each dependent claim in combination with every other claim in the claim set. As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiple of the same item.

When “a processor” or “one or more processors” (or another device or component, such as “a controller” or “one or more controllers”) is described or claimed (within a single claim or across multiple claims) as performing multiple operations or being configured to perform multiple operations, this language is intended to broadly cover a variety of processor architectures and environments. For example, unless explicitly claimed otherwise (e.g., via the use of “first processor” and “second processor” or other language that differentiates processors in the claims), this language is intended to cover a single processor performing or being configured to perform all of the operations, a group of processors collectively performing or being configured to perform all of the operations, a first processor performing or being configured to perform a first operation and a second processor performing or being configured to perform a second operation, or any combination of processors performing or being configured to perform the operations. For example, when a claim has the form “one or more processors configured to: perform X; perform Y; and perform Z,” that claim should be interpreted to mean “one or more processors configured to perform X; one or more (possibly different) processors configured to perform Y; and one or more (also possibly different) processors configured to perform Z.”

No element, act, or instruction used herein should be construed as critical or essential unless explicitly described as such. Also, as used herein, the articles “a” and “an” are intended to include one or more items, and may be used interchangeably with “one or more.” Further, as used herein, the article “the” is intended to include one or more items referenced in connection with the article “the” and may be used interchangeably with “the one or more.” Furthermore, as used herein, the term “set” is intended to include one or more items (e.g., related items, unrelated items, or a combination of related and unrelated items), and may be used interchangeably with “one or more.” Where only one item is intended, the phrase “only one” or similar language is used. Also, as used herein, the terms “has,” “have,” “having,” or the like are intended to be open-ended terms. Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

In the preceding specification, various example embodiments have been described with reference to the accompanying drawings. It will, however, be evident that various modifications and changes may be made thereto, and additional embodiments may be implemented, without departing from the broader scope of the invention as set forth in the claims that follow. The specification and drawings are accordingly to be regarded in an illustrative rather than restrictive sense.

What is claimed is:

1. A method comprising:
receiving, by a first network device, log data identifying user equipment (UE) mobility information for a set of UEs;
training, by the first network device, a model of UE mobility based on the log data;
receiving, by the first network device, UE mobility information for a particular UE, based on training the model of UE mobility;
analyzing, by the first network device and using the model of UE mobility, the UE mobility information for the particular UE to predict a location of the particular UE;
generating, by the first network device and based on predicting the location of the particular UE, a set of recommended cells for paging the particular UE; and
transmitting, by the first network device, information identifying the set of recommended cells.

2. The method of claim 1, further comprising:
receiving, by the first network device, updated mobility information for the set of UEs; and
updating, by the first network device, the model of UE mobility based on receiving the updated mobility information for the set of UEs.

3. The method of claim 1, wherein the set of recommended cells is based on timing information, the timing information relating to at least one of a time of day, or a day of a week.

4. The method of claim 1, further comprising:
receiving, by the first network device, a request to enable use of the model of UE mobility; and
wherein analyzing the UE mobility information for the particular UE to predict the location of the particular UE comprises:
analyzing, by the first network device, the UE mobility information for the particular UE using the model of UE mobility based on receiving the request to enable use of the model of UE mobility.

5. The method of claim 4, wherein a default paging scheme is configured for a subsequent paging cycle in which use of the model of UE mobility is disabled.

6. The method of claim 1, further comprising:
receiving, by the first network device, a request for the set of recommended cells; and
wherein transmitting the information identifying the set of recommended cells comprises:
transmitting, by the first network device, the information identifying the set of recommended cells based on receiving the request for the set of recommended cells.

7. The method of claim 1, wherein the particular UE is included in the set of UEs.

8. The method of claim 1, wherein analyzing the UE mobility information for the particular UE comprises:
calculating, by the first network device, a movement path of the particular UE; and
predicting, by the first network device, the location of the particular UE based on the movement path.

9. The method of claim 1, wherein the model of UE mobility is a machine learning probability model.

10. The method of claim 1, wherein analyzing the UE mobility information for the particular UE comprises:
determining, by the first network device and using the model of UE mobility, a probability of the particular UE being in a particular cell; and
determining, by the first network device, whether to include the particular cell in the set of recommended cells based on the probability of the UE being in the particular cell.

11. The method of claim 1, wherein the particular UE is operating in one or more cells associated with a virtualized radio access network (VRAN) with a split central unit (CU) and distributed unit (DU) architecture.

12. A system, comprising:
one or more processors configured to:
receive log data identifying user equipment (UE) mobility information for a UE;
train a model of UE mobility based on the log data;
analyze, using the model of UE mobility, the UE mobility information for the UE to predict a location of the UE;
generate, based on predicting the location of the UE, a set of recommended cells for paging the UE; and
transmit, one or more paging messages toward the UE in one or more cells of the set of recommended cells.

13. The system of claim 12, wherein the one or more processors are further configured to:
disable use of the model of UE mobility; and
revert to paging using a default paging scheme for one or more subsequent paging messages based on disabling use of the model of UE mobility.

14. The system of claim 12, wherein the one or more processors are further configured to:
receive handover logs indicating active state transitions of the UE during a sampled period interval; and
wherein the one or more processors, to train the model of UE mobility, are configured to:
train the model of UE mobility based on the handover logs and the active state transitions of the UE during the sampled period interval.

15. The system of claim 12, wherein the one or more processors are further configured to:
receive updated UE mobility information after training the model of UE mobility; and
wherein the one or more processors, when analyzing the UE mobility information to predict the location of the UE, are configured to:
process the updated UE mobility information to calculate a movement path; and
predict the location of the UE based on the movement path.

16. A non-transitory computer-readable medium storing a set of instructions, the set of instructions comprising:
one or more instructions that, when executed by one or more processors of a second network device, cause the second network device to:
receive, from a user equipment (UE), a request for paging;
transmit, to a first network device, log data identifying UE mobility information for the UE;
receive, from the first network device, information identifying a set of recommended cells for paging, wherein the set of recommended cells for paging is based on an output of a machine learning model analyzing the log data identifying the UE mobility information for the UE; and
transmit, to the UE, one or more paging messages in one or more cells associated with the set of recommended cells for paging.

17. The non-transitory computer-readable medium of claim 16, wherein the request for paging is associated with a handover request or a tracking area update.

18. The non-transitory computer-readable medium of claim 16, wherein the set of recommended cells is based on timing information or movement pattern information of the log data.

19. The non-transitory computer-readable medium of claim 16, wherein the one or more instructions further cause the second network device to:
transmit a request to deactivate the machine learning model; and
revert to a static paging procedure based on transmitting the request to deactivate the machine learning model.

20. The non-transitory computer-readable medium of claim 19, wherein the one or more instructions further cause the second network device to:
evaluate the set of recommended cells using one or more evaluation criteria; and
select the one or more cells for paging based on evaluating the set of recommended cells using the one or more evaluation criteria.
